(19) United States
(12) Patent Application Publication
(10) Pub. No.: US 2004/0253923 A1
(43) Pub. Date: Dec. 16, 2004

(54) System and method for electronically pairing devices

(76) Inventors: Richard C. Braley, Collierville, TN (US); Terrance P. Hollahan, Collierville, TN (US); Nathan Lemmon, Memphis, TN (US); Chris J. Naugle, Memphis, TN (US); John G. Pantlik, Memphis, TN (US)

Correspondence Address: Finnegan, Henderson, Farabow,, Garrett & Dunner, L.L.P., 1300 I Street, N.W., Washington, DC, 20005-3315, US

(21) Appl. No.: 10/459,481

(22) Filed: Jun. 12, 2003

(51) Int. Cl. H04Q 7/20; H04M 11/00

(52) U.S. Cl. 455/41.2; 455/403

(57) ABSTRACT

A system and method for pairing wireless communication devices on a wireless personal area network allows communication between wireless communication devices and a master devices through the use of radio addresses. A barcode associated with each wireless communication is scanned by the master device. The scanned barcode is converted to a radio address associated with the scanned barcode. Software associated with the master device allows communication between the master device and the network devices through the use the radio addresses. The system of and method for pairing network devices on a wireless personal area network allows quicker and more efficient pairing of network devices when multiple wireless personal area networks are present in a confined space.

### DESCRIPTION OF THE INVENTION

1. Field of the Invention

The present invention relates generally to the pairing of electronic devices on a personal area network, and more particularly to a method and system for pairing devices, such as personal digital assistants (PDAs), to other devices on a wireless personal area network, using radio technology (for example, Bluetooth) through use of barcode labels and scanners.

2. Background of the Invention

In wireless personal area networks (WPANs) today, devices communicating though radio frequency channels associate with one another using a process known as discovery. In the discovery process, a master device, or requester, creates a list of all the devices within a range of the master device. After a complete list of devices has been created, a user selects the devices that should be included within the user's WPAN. The radio addresses for those devices are then associated with a communications port of the master device.

FIG. 1 shows a flowchart for a method 100 for pairing devices using the discovery method. The process starts at stage 102 where the master device searches for all network devices that may be in the range of the master device and are able to communicate with the master device. At stage 104, the names of all these network devices are identified and displayed on the master device, for example, as a pick list for the user. Depending on the number of devices that may be in range of the requester, searching and identifying all the devices may take as long as several minutes. At stage 106, a user reviews the list of identified devices to select those devices that should be included into the user's WPAN. If the user does not find all the devices that should be in the user's WPAN, the search and identification processes at stages 102 and 104 must be repeated (stage 108). If all the devices have been identified, the user selects those devices (stage 110) so that each device's radio address is associated with a communications port of the master device (stage 112). The master device may be a PDA using Bluetooth technology to communicate with the network devices. The network devices may be devices typically associated with a network such as a printer or computer.

However, the discovery process has limitations and drawbacks. For example, the discovery process requires that all network devices within the range of the master device be identified before the user selects the relevant devices for the user's WPAN. As noted above, this process may take as long as several minutes and can be further extended if all the devices are not identified or if many devices are present in a confined space within the range of the master device. The complete list may also contain many devices that are irrelevant to the user, such as devices associated with the other users' WPAN but within the range of the user's master device. In addition, if there are many users within a restricted area, the discovery process may become cumbersome and time consuming due to interference between the WPANs of the users.

It is therefore desirable to provide a system and method for pairing devices within a wireless personal area network that is less time consuming and more efficient for associating devices to a user's wireless personal area network.

### SUMMARY OF THE INVENTION

In accordance with the invention, there is provided improved systems and methods for pairing network devices, each network device having a communication radio, on a wireless personal area network. The network includes a master device, having a scanner and a master radio. The scanner scans at least one network device, by scanning a label associated with each scanned network device, based on the information read from the scanned label(s). The system also comprises a memory storage, associated with the master device, which stores a radio address associated with each scanned network device. The master device is capable of establishing a wireless connection between the master radio and the communication radio for each scanned network device so that the master device and the scanned network devices can communicate. The label has information that determines the radio address and may be a barcode label.

There is also provided a method for exchanging information on a wireless personal area network. The method comprises scanning a label (e.g., a barcode label) located on a network device using a scanner on a master device; receiving information at the master device regarding the network device; storing the information in a memory storage facility associated with the memory device; establishing a connection between the master device and the network device using the received information; and communicating, by the master device, with the network device.

There is also provided a data processing system-readable medium having a plurality of instructions executable by a data processing system embodied therein. The instructions when executed cause the data processing system to retrieve information stored in a memory storage facility regarding data scanned from at least one network device by a master device. The instructions establish a connection between a master radio in the master device and a communication radio from each scanned network device using the information.

Additional features and advantages will be set forth in part in the description which follows, and in part will be obvious from the description, or may be learned by practice of the claims. The features and advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is a flowchart of a method to pair wireless communication devices using a discovery method.

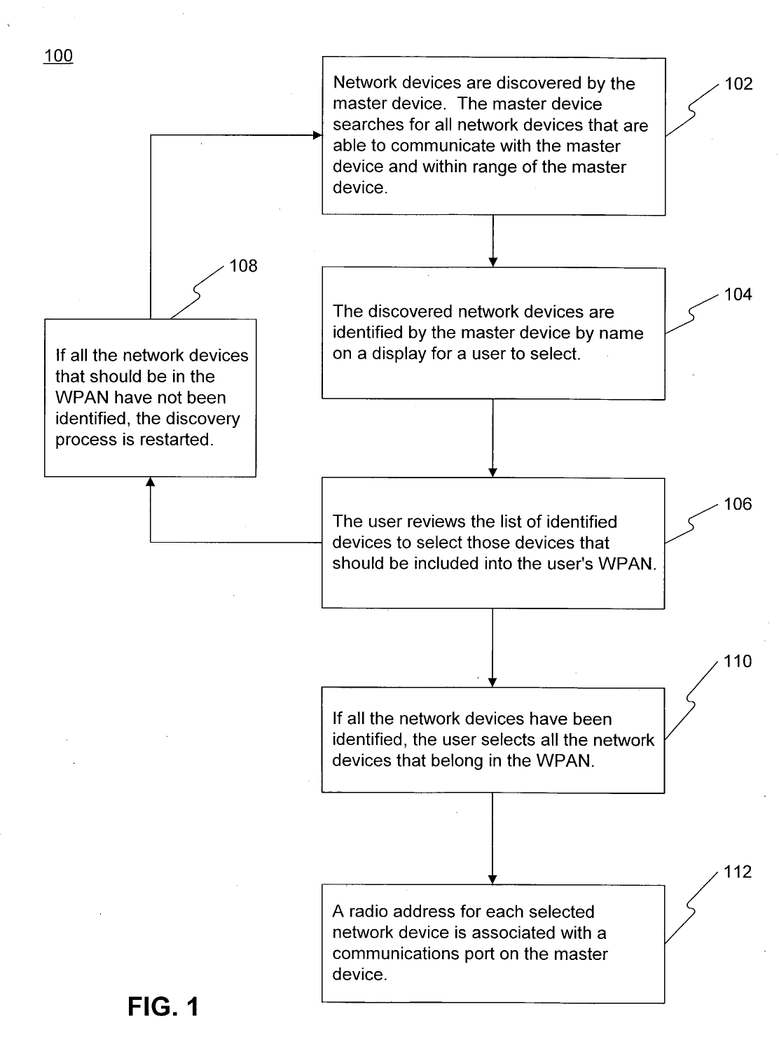

FIG. 2 is a flowchart of a method to pair wireless communication devices consistent with the present invention.

FIG. 3 is a system for pairing wireless communication devices consistent with the present invention.

FIG. 4 is a flowchart of a process for establishing communication between a master device and network devices.

It is to be understood that both the foregoing general description and the following detailed description are exemplary and explanatory only and are not restrictive of the invention, as claimed.

### DESCRIPTION OF THE EMBODIMENTS

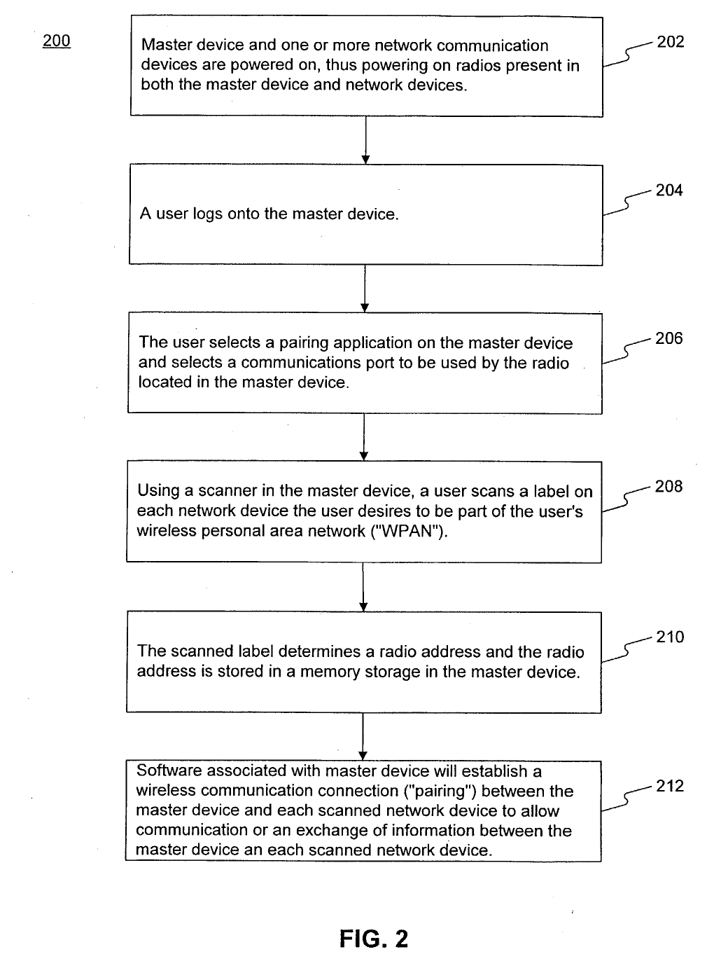

Referring now to the drawings, in which the same reference numbers will be used throughout the drawings to refer to the same or like parts, FIG. 2 is a flowchart of a method 200 for pairing network devices on a wireless network. A method for pairing network devices on a wireless network begins at a stage 202, where a master device and one or more network devices are powered on. Powering on the master device and the network devices activates radios located in the master device and the network devices. At stage 204, a user logs onto the master device. The user selects a pairing application on the master device and a communications port on the master device to be used by the radio in the master device (stage 206). For example, pairing applications may include setting up communications between a PDA (such as a PDA for a courier using a delivery vehicle) and a computer (such as a computer within the delivery vehicle). Another pairing application may be setting up communications between a PDA and a printer, for printing out an airbill tag that may be affixed to a package for use in delivering and tracking a package.

At stage 208, the user scans a label located on each of the network devices using a scanner on the master device that is able to read the labels. The user may scan only the labels for those network devices the user desires to be included within the user's wireless personal area network (“WPAN”). The label may be a barcode label containing information, such as a radio address, associated with the scanned network device.

For a preferred embodiment, the barcode label will contain the specific radio address of the network devices, so that the master device can directly read the radio address. Other labels having readable information identifying a radio address, or associated with a radio address, can also be used. The radio address for each scanned network device is stored in a memory storage in the master device at stage 210. The read information could in an alternative embodiment correspond to a radio address that is in the memory of the master device. For example, the read information could be the number 1, the master device knowing that the radio for device number 1 was a given address, which is stored in the memory of the master device.

At stage 212, a software component in the master device establishes a wireless communication connection (“pairing”) between the master device and each scanned network device to allow communication or an exchange of information between the master device and each scanned network device. The barcode label may be a typical UPC barcode label known in the art, although other types of readable labels or markings on a device can also be used.

The master device may be any device that has the capability to scan labels, or other markings or symbols, for example, a PDA or any device with a scanner using Bluetooth technology. The network devices may also include any device that has Bluetooth or other communication capability, for ex ample, a printer, a computer, a cellular phone, a computer and a radio, or other such devices.

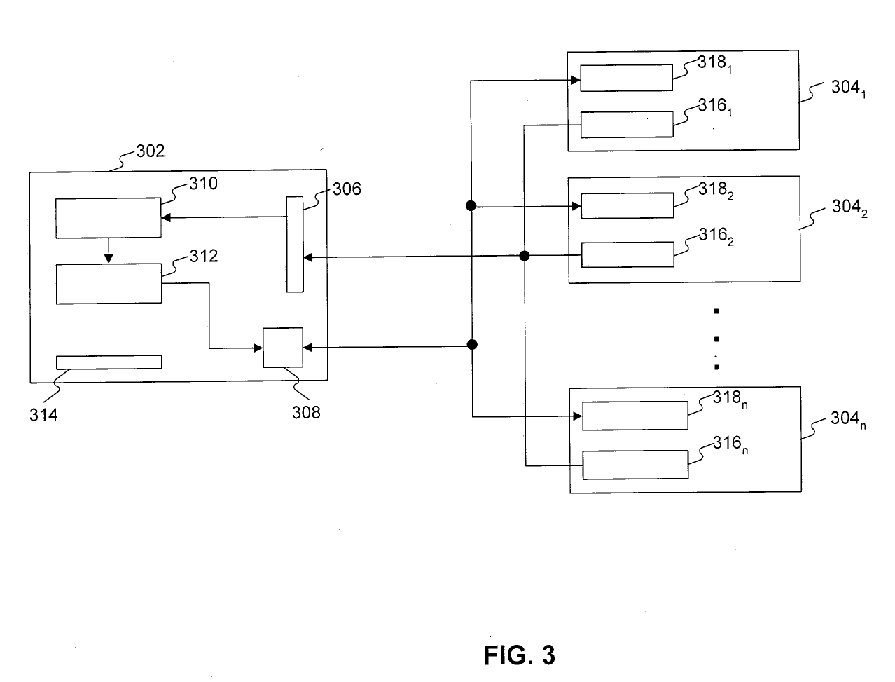

FIG. 3 is an illustration of a system 300 for pairing network devices on a wireless personal area network. System 300 may include a master device 302 and network devices 304₁ through 304ₙ. Master device 302 may include scanner 306, radio 308, memory storage 310, software component 312, and label 314. Network devices 304₁ through 304ₙ may include labels 316₁ through 316ₙ, respectively, and radios 318₁ through 318ₙ, respectively.

Using scanner 306, master device 302 scans or reads one or more labels 316₁ through 316ₙ from devices 304₁ through 304ₙ. Labels 316₁ through 316ₙ may be barcode labels that contain information or data identifying respective device 304₁ through 304ₙ, respectively. The identifying information may be a radio address used by typical short range radios known in the art. Radios 308 and 318₁ through 318ₙ may be short range radios, each having a radio address that uniquely defines master device 302 or any of devices 304₁ through 304ₙ. Since each radio address may be unique, each label 316₁ through 316ₙ may also be unique. As noted above, the barcode labels may be typical UPC barcode labels or other readable labels, markings, or symbols known in the art.

The information on each of scanned labels 316₁ through 316ₙ may be saved in master device 302 by storing the information in memory storage 310. For example, the radio addresses for each of scanned devices 304₁ through 304ₙ may be stored in memory storage 310. Master device 302 will use the stored information for each of scanned devices 304₁ through 304ₙ to identify and communicate with each of scanned devices 304₁ through 304ₙ.

Master device 302 communicates with each of scanned devices 304₁ through 304₁ by using the information stored in memory storage 310. Master device 302 may use software component 312 to establish a connection with each of scanned devices 304₁ through 304ₙ. Software component 312 may use the stored information (e.g., the radio addresses for each of scanned devices 304₁ through 304ₙ) to establish the connection. The connection is established when radio 308 of master device 302 communicates with the desirable scanned device 304₁ through 304ₙ through one of radios 318₁ through 318ₙ. Once the connection is established, master device 302 may exchange information with any of scanned devices 304₁ through 304ₙ or vice versa.

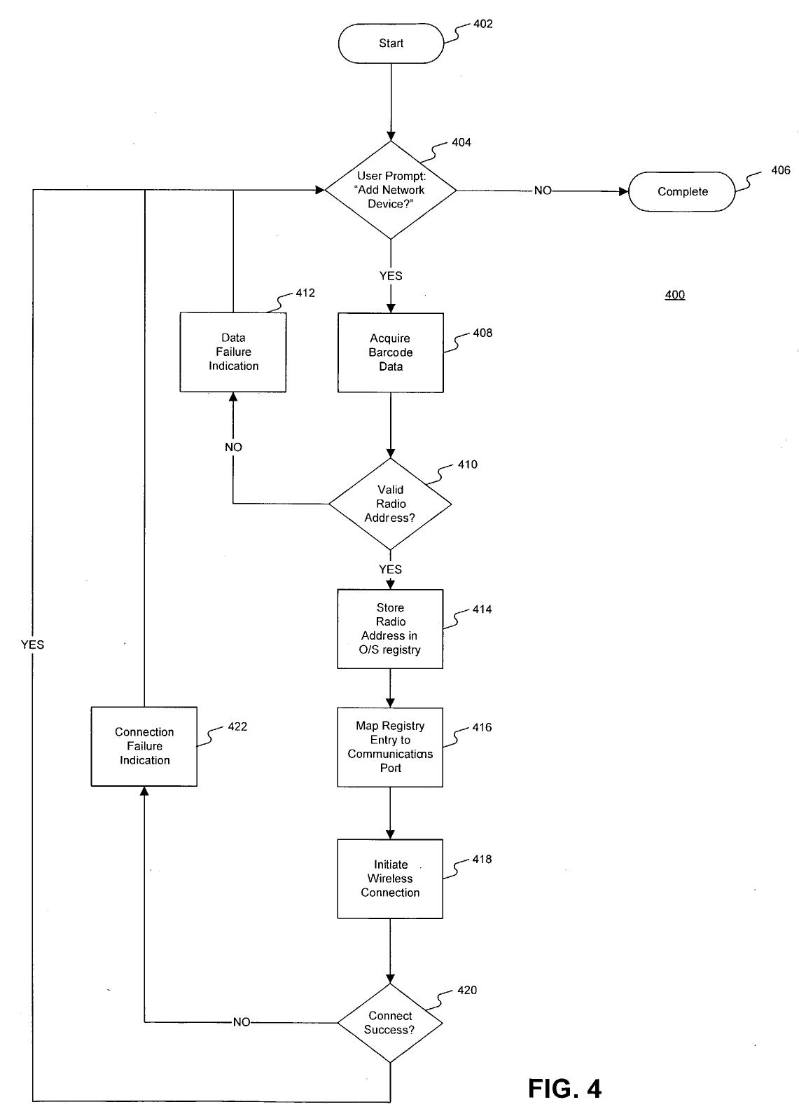

FIG. 4 illustrates a flowchart 400 for a connection process between a master device and one or more network devices. The connection process starts at stage 402, which may be the powering on of the master device. At stage 404, the master device may display a user prompt for adding a network device. If the user does not wish to add the network device, the process is complete (stage 406). At stage 408, if the user does wish to add a network device, the data from a label on the network device is acquired (data acquisition period). As noted earlier, the label may be in the form of a UPC barcode label. At stage 410, the master device checks if the information on the label (such as a radio address which uniquely identifies the network device) is a valid address. If the radio address is not valid, a data failure is indicated to the user and the process returns to stage 404 (stage 412). If the radio address is valid, the radio address is stored in an operating system registry at stage 414. At stage 416, the registry is mapped to a communications port, so that a communications port on the master device is associated with the communications port of the network device of interest. The mapping function and operating system may be implemented using software component 312 as noted above. More details on software component 312 is provided below. At stage 418, a wireless connection is initiated. As noted above, the wireless connection may be utilized using Bluetooth technology that is known and used in the art, although the invention is not limited to this form of communication. At stage 420, if the connection is successful, the process is returned to stage 404 so that user may add other network devices. If the connection is not successful at stage 420, a connection failure is indicated to the user at stage 412, and the process returns to stage 404.

Stages 414 and 416 may use software located in the master device, such as software component 312. Referring to FIG. 3, software component 312 may utilize code fragments that allow a user to start the data acquisition period. The code fragments may be programmed using the computer language C. Software component 312 may be a data processing system-readable medium having a series of instructions (e.g., the medium may be in the form of memory containing software code programmed in the computer programming language C). The series of instructions may be executed by a data processing system (e.g., master device 302). Software component 312 may be a computer operating system that allows an association of the logical communications ports of master device 302 and network devices 304, through 304ₙ. For example, software component 312 may be, but is not limited to, a Microsoft based operating system, such as Pocket PC. Other operating systems may be used for communication between master device 302 and network devices 304₁ through 304ₙ, such as the Palm operating system.

The data acquisition period may be a time when master device 302 scans information from labels 316₁ through 316ₙ. After the data acquisition period, the data is stored in memory storage 310. Memory storage 310 may be in the form of a registry that is populated with the data or information acquired from labels 316₁ through 316ₙ. The acquired data is populated in such a manner so that the data for each of network devices 304₁ through 304ₙ can be identified with each of network devices 304₁ through 304ₙ by software component 312. Because each of labels 316₁ through 316ₙ is uniquely associated with each of scanned devices 304₁ through 304ₙ, respectively, software component 312 may associate the populated data for each of network devices 304₁ through 304ₙ in the registry (e.g., memory storage 310) with each of devices 304₁ through 304₁. Using the data populated in the registry, software component 312 may make an association between a logical communications port on master device 302 with logical communications ports on scanned devices 304₁ through 304ₙ. This allows master device 302 to communicate with any of scanned devices 304₁ through 304ₙ. System 300 may utilize known or later developed technology to allow communication between devices, such as Bluetooth technology, which allows devices to communicate and exchange information wirelessly and is currently known and used in the art.

Master device 302 may be an electronic handheld device, such as a PDA, that contains scanner 306. Scanner 306 may read labels 316₁ through 316ₙ on network devices 304₁ through 304ₙ using Bluetooth technology. This allows the PDA to connect with one or all of network devices 304₁ through 304ₙ. For example, one of network devices 304, through 304ₙ may be a printer. Among other functions, the PDA may transfer information regarding a package to the printer, so that the printer may print out an airbill tag that may be affixed to the package. The airbill tag may uniquely identify the package from other packages and may be used for tracking purposes. The operator of the PDA may be a courier for a package delivery service. Other network devices include, but are not limited to, a headset worn by the courier, a phone, smartphone, a personal computer on a customer's computer network, or a serial port adapter. The serial port adapter allows connectivity to other devices that may be present in a delivery vehicle used by the courier, such as a computer terminal or a laptop computer. In addition, master device 302 may communicate with other master devices for other users' WPAN. For this purpose, label 314 may be included with master device 302.

Other embodiments will be apparent to those skilled in the art from consideration of the specification and practice of the claims disclosed herein. It is intended that the specification and examples be considered as exemplary only, with a true scope and spirit being indicated by the following claims.

What is claimed is:

1. A system for pairing network devices, each network device having a communication radio, on a wireless personal area network, comprising:
a master device;
one or more network devices having on its exterior readable data representative of the radio address of the network device;
said master device, having a scanner and a master radio, for scanning the readable information of at least one network device; and
a memory storage, associated with the master device, which stores the readable information associated with each scanned network device;
wherein the master device is capable of establishing a wireless connection between the master radio and the communication radio for each scanned network device so that the master device and the scanned network devices can communicate.

2. The system of claim 1 wherein the readable information is contained on a label.

3. The system of claim 1 wherein the master device scans the label of at least one network device.

4. The system of claim 2, wherein a radio address for each scanned network device is associated with a communications port on the master device.

5. The system of claim 1, wherein the label is a barcode.

6. The system of claim 1, wherein the master device has a master barcode label.

7. The system of claim 1, wherein the master device is a personal digital assistant (PDA).

8. The system of claim 1, wherein at least one wireless network device comprises a printer.

9. The system of claim 1, wherein at least one wireless network device comprises a phone.

10. The system of claim 1, wherein at least one wireless network device comprises a smartphone.

11. The system of claim 1, wherein at least one wireless network device comprises a serial port adapter.

12. The system of claim 1, wherein at least one wireless network device comprises a headset.

13. The system of claim 1, wherein at least one wireless network device comprises a computer terminal.

14. The system of claim 1, wherein at least one wireless network device comprises a laptop computer.

15. The system of claim 1, wherein at least one wireless network device comprises a personal computer on a customer's computer network.

16. The system of claim 1, wherein the master device and at least one wireless network device communicate using Bluetooth technology.

17. A method for exchanging information on a wireless personal area network including a master device and at least one network device, comprising the steps of:
scanning readable information located on a network device using a scanner on a master device;
receiving information at the master device regarding the network device;
storing the information in a memory storage facility associated with the memory device;
establishing a connection between the master device and the network device using the received information; and
communicating, by the master device, with the network device.

18. The method of claim 17, further comprising associating a radio address for each scanned network device on a communications port located on the master device.

19. The method of claim 17, wherein the step of scanning comprises scanning a barcode label.

20. The method of claim 17, wherein the step of scanning comprises a personal digital assistant (PDA) scanning the label.

21. The method of claim 17, wherein the step of scanning comprises the master device scanning a label from a printer.

22. The method of claim 17, wherein the step of scanning comprises the master device scanning a label from a phone.

23. The method of claim 17, wherein the step of scanning comprises the master device scanning a label from a smartphone.

24. The method of claim 17, wherein the step of scanning comprises the master device scanning a label from a serial port adapter.

25. The method of claim 17, wherein the step of scanning comprises the master device scanning a label from a headset.

26. The method of claim 17, wherein the step of scanning comprises the master device scanning a label from a computer terminal.

27. The method of claim 17, wherein the step of scanning comprises the master device scanning a label from a laptop computer.

28. The method of claim 17, wherein the step of scanning comprises the master device scanning a label from a personal computer on a customer's computer network.

29. The method of claim 17, wherein the step of communicating comprises the master device and network device exchanging information using Bluetooth technology.

30. A data processing system-readable medium having a plurality of instructions executable by a data processing system embodied therein, wherein the instructions when executed cause the data processing system to:
retrieve information stored in a memory storage facility regarding data scanned from at least one network device by a master device; and
establish a connection between a master radio in the master device and a communication radio from each scanned network device using the information.

31. The data processing system-readable medium of claim 30, wherein the connection is established using Bluetooth technology.

32. The data processing system-readable medium of claim 30, wherein the information is a radio address uniquely identifying each network device

33. The data processing system-readable medium of claim 30, the plurality of instructions when executed further cause the data processing system to associate a radio address for each scanned network device on a communications port located on the master device.
